(19) United States
(12) Patent Application Publication
(10) Pub. No.: US 2004/0135335 A1
(43) Pub. Date: Jul. 15, 2004

(54) Device for hitching a direct-link vehicle to the wheel axles and truck tractor equipped with the same

(76) Inventors: Claude Fior, Nogaro (FR); Fabien Fior, Nogaro (FR); Celine Fior, Caupenne d'Armagnac (FR)

Correspondence Address: LEYDIG VOIT & MAYER, LTD, 700 THIRTEENTH ST. NW, SUITE 300, WASHINGTON, DC, 20005-3960, US

(21) Appl. No.: 10/451,245

(22) PCT Filed: Dec. 20, 2001
(86) PCT No.: PCT/FR01/04096

(30) Foreign Application Priority Data
Dec. 21, 2000 (FR) 00/16782

(51) Int. Cl. B60G 1/00

(52) U.S. Cl. 280/124.1

(57) ABSTRACT

The invention concerns a truck tractor hitching device comprising at least a drive wheel (2g, 2d) suspended to a chassis (5) via an axle (9g, 9d), including means (22g, 22d, 20g, 20d, 24g, 24d) for directly linking the axle (9g, 9d) to at least a wheel at the central plate fitting (10) transmitting a longitudinal horizontal component of the drawbar pull and enabling the relative vertical displacements of said axle (9g, 9d) relative to the central plate fitting (10). The invention also concerns a truck tractor equipped with such a hitching device and is applicable in particular to light-chassis vehicles such as heavy tricycles or quadricycles.

The invention relates to a coupling device for a vehicle, in particular for a powered towing vehicle for the road transportation of people and/or materials and/or objects. It extends to powered vehicles fitted with such coupling devices.

Until now, coupling devices for towing vehicles comprised of a central base plate designed to be fitted with a hitch ball for the towing of a trailer, this central base plate being attached to the chassis of the towing vehicle and capable of conveying the tractive forces. Thus, the fitting of the central base plate to the chassis, as well as that of the part of the chassis to which this central base plate is attached must be sized up so as to be sufficiently strong to convey all of the tractive forces. More generally, it is the entire drive train between the central base plate and the drive wheels of the towing vehicle, from which originates either the driving or resisting force in relation to the ground, that must bear and convey all the tractive forces, and must consequently be sized up. This means that the towing vehicle is both heavy and expensive. In particular, some light vehicles (e.g. those in the regulatory category of light and heavy quadricycles) can not be fitted with a coupling device.

In addition, it is to be noted that as the central base plate is placed relatively high off the ground, the tractive forces can induce—particularly on a bend—an anti-roll (rolling) component of one and/or the other of the two coupled vehicles.

The invention aims at compensating these inconveniences, by offering a simple, economic and efficient coupling device.

The invention particularly aims at offering a coupling device that is compatible with a light-chassis towing vehicle, and which does not require that the chassis is sized up so that it is subject to and conveys all the tractive forces.

In addition, the invention aims at offering a coupling device that does not significantly increase the non-suspended weight of the rear axle of the towing vehicle.

The invention, more particularly, aims at offering a coupling device that is compatible, not only with all types of towing vehicles, but also with light vehicles such as those within the regulatory category of tricycles or powered quadricycles.

The invention also aims at offering a vehicle that is fitted with a coupling device and whose chassis is not subject to and does not convey all the tractive forces, and does not need to be especially designed for this purpose. The invention also aims at offering such a towing vehicle that could be in the light category and have a light chassis, particularly within the regulatory category of tricycles or powered quadricycles.

Throughout the text, the expression “spindle” represents all non-turning parts supporting a hub. The longitudinal and transversal directions refer to those of the vehicle.

The invention relates to a coupling device of a towing vehicle comprising at least a driving axle with at least one driven wheel coupled to the transmission facility of an engine motion, and suspended by a suspension facility to a chassis of the vehicle via a spindle supported by a mobile part of the suspension facility, this device comprising a central coupling base designed to be fitted with coupling facilities for a trailer for the purpose of towing, and to convey the tractive forces, characterised in that it comprises direct connection facilities from the spindle of at least one axle wheel to the central base plate adapted to directly convey, between the said spindle—notably each spindle—and the central base plate, a horizontal longitudinal component of the tractive forces, allowing the vertical relative displacements of the said spindle—notably of each spindle—in relation to the central base plate.

Thus, the said direct connection facilities of a coupling device according to the invention do not constitute a rigid connection from the base to the spindle(s). In particular, the direct connection facilities do not convey to the spindle(s) the downward vertical forces subjected to the central base plate due to the trailer. The forces imparted to the spindle(s) on the coupling device therefore do not have any downward vertical components or at least this component is weak and insignificant (it only results from the difference in height between the central base plate and the spindle(s) and not the weight or the vertical reactions subjected to the central base plate due to the trailer).

Favourably and according to the invention, the coupling device is designed so that the horizontal component of the tractive forces is directly conveyed, entirely or partially, by the said direct connection facilities, and solely via the direct connection facilities, independently of the chassis, between the said spindle and the central base plate, and so that a downward vertical component—notably all vertical components—of the tractive forces subject to the central base plate is directly conveyed to the chassis and not the said spindle.

With a coupling device according to this invention, the horizontal longitudinal tractive forces are directly conveyed between the wheel spindle(s) and the central base plate by direct connection facilities, and the chassis thus does not need to be especially designed to support and convey these horizontal longitudinal tractive forces. The horizontal longitudinal forces resulting from the interface between the ground and the drive wheel(s) are conveyed to the interdependent spindle(s) attached to the wheel(s), and directly by the said direct connection facilities, to the central base plate. It is to be noted in this respect that the suspension facilities and the corresponding part of the chassis, having normally to be designed to support and convey the forces between the wheel and the chassis for the working of the towing vehicle without a trailer, no modifications are normally to be envisaged due to the addition of a coupling device. If further restrictions, forcibly weak, are induced in the suspension facilities and/or in

their fitting to the chassis due to the coupling device (e.g. in the case where the horizontal tractive forces are not exactly perpendicular to the wheel axis in respects to the spindle), it is easy and inexpensive to consequently strengthen or adjust the suspension facilities and/or the fitting to the chassis.

In addition, the horizontal tractive and/or reaction forces apply at a minimal height from the ground (at the level of the spindle(s)), and only induce a limited rolling effect on the vehicle in bends. In addition, the coupling device according to the invention bearly modifies the suspended weight of the axle. This results in an improved dynamic oversteering/understeering performance and increased operating safety of the vehicles coupled to one another.

The mobile part of the suspension facilities of a vehicle wheel has relative height motion (with at least one vertical component) in respects to the chassis.

The relative vertical displacement of the spindle and of the central base plate do not necessarily correspond to the genuine displacements of the spindle and/or of the central base plate. Indeed, it is sufficient that the spindle can freely follow the course of the suspension facilities with regard to the chassis without these courses being interfered with by the connection facilities to the base. These courses comprise a vertical component but may be tilted longitudinally and/or sideways, or even curvilinearly. In addition, the relative displacements of the spindle compared to the base, other than vertical, may or may not be authorised for as long as the horizontal component of the tractive forces is conveyed between the spindle and the base (in one direction or the other, depending on whether the tractive forces are driving or resisting).

According to a possible alternative to the invention, the central base plate is nowhere else attached to the chassis when coupled with a trailer. In this alternative, the central base plate is not held up by the chassis. It can however be held up by the trailer (which must therefore by horizontally stabile) and/or by one or several special wheels linked to the coupling device and which rest on the ground. It can also be envisaged either that the direct connection facilities can be detached from the spindle(s) (so that the coupling device can be removed from the towing vehicle when there is no trailer), or that there exist central base plate support facilities with regard to the chassis, when there is no trailer, so as to prevent the central base plate dropping to the ground.

Nevertheless, more preferably in another alternative, favourably and according to the invention, the coupling device comprises retention facilities to link the central base plate to the chassis and designed so that the downward vertical component of the forces, known as tractive forces, subjected to the central base plate, is conveyed to the chassis. The retention facilities are designed to allow certain rotation and/or translation motions of the central base plate with regard to the chassis, but to at least roughly inhibit the downward displacement of the central base plate (in translation or rotation) starting from a normal position.

Favourably and according to the invention, the coupling device according to the invention is characterised in that the retention facilities are designed to at least roughly support the central base plate at a pre-set height with regard to the chassis—notably, at least roughly the same as that of the spindle(s) at engine cut-off or slightly higher, this height being either pre-set or adjustable—and to convey to the chassis the vertical component of the tractive forces subjected to the central base plate, and in that the direct connection facilities are designed to allow relative vertical displacements of the said spindle with regard to the central base plate and at least roughly independently from the central base plate depending on the motion of the mobile part of the suspension facilities with regard to the chassis.

Thus, even though the coupling device according to the invention is directly coupled to the wheel spindle(s), it only applies an insignificant vertical force on the spindle(s), very slightly increases the non-suspended weight of the drive axle, and barely affects the performance of the wheel(s) and suspension. Indeed, the vertical component of the tractive forces is subject to the retention facilities which re-convey it to the chassis or by the trailer (for a stable trailer) or is re-conveyed directly to the ground (for specific wheels). On the contrary, a coupling device solidly attached to a drive axle, e.g. to the drive axle, would result in burdening the non-suspended weight of the drive axle, degrading the driving performance of the vehicle. We know that the driving performance of a vehicle is largely affected by the non-suspended weight of its axles. Thus a coupling device according to the invention is neither totally attached to the chassis nor totally attached to the spindles or the drive axle.

Favourably and according to the invention, the retention facilities comprise a retention beam articulated at one of its ends to a fixed point on the chassis and linked via another of its ends to the central base plate.

More preferably, the said articulated retention beam is designed and assembled with regard to the chassis so that it extends downwards from its end articulated to the chassis—notably, at least roughly vertically—in normal position, its lower end being linked to the central base plate which is thus suspended from the retention beam and could experience oscillating motion (of minor intensity) with regard to the chassis.

The fitting of the retention beam (to the chassis and the central base plate) is designed so as not to bear any resistance to the horizontal tractive forces (longitudinal and/or transversal) which are only conveyed by the said direct connection facilities.

Favourably and according to the invention, the articulation of the retention beam to the chassis comprises two orthogonal swivel axes, one of which being a horizontal transversal swivel axis and the other a horizontal longitudinal swivel axis. These swivel axes can be secant, in which case it is a central point connection that can be made, for example, of a knuckle or a gimbal joint.

Thus, favourably and according to the invention, the articulation of the retention beam to the chassis is a central point connection. Alternatively, the orthogonal swivel axes can be disjoint (non-secant). In another favourable alternative to the invention which is particularly economic, the articulation of the retention beam to the chassis comprises a swivel axis fitted with a radial play capable of allowing the relative motions according to a pre-set amplitude perpendicular to this swivel axis. For example, the swivel axis is fitted with an interposition resilient cylinder, notably of silent block type, allowing rotation and/or translation radial motions with a defined limited amplitude.

Alternatively, the retention facilities can be implemented by any other equivalent manner. The principal criterion to be adhered to in this regard is that the retention facilities bear no resistance (apart from friction) to the horizontal longitudinal tractive forces. For example, the retention facilities could be made of a cable, a guide in a horizontal plane (via two orthogonal horizontal slides or by a simple horizontal slide plate . . . ).

In addition, in a more preferable embodiment particularly favourable and according to the invention, the direct connection facilities comprise at least a fixed length stay rod of which one end is articulated to the spindle via an articulation, known as a spindle articulation, and of which a second end is linked to the central base plate and/or to the second end of another stay rod whose first end is articulated to an opposing wheel spindle. A single stay rod can be envisaged for each spindle (only one side of the wheel, notably the inside in the case of a lateral wheel axle) or two stay rods, one on each side, forming a towing fork, in particular in the case of a single wheel axle (i.e. a motorcycle wheel).

In an embodiment, the axle is of a broken type and has at least two independent, opposing lateral wheels with independent suspension facilities. The coupling device according to the intervention is characterised in that it comprises direct connection facilities, to the central base plate, of each spindle of at least two opposing lateral wheels—notably the inside opposing wheels if several wheels are envisaged for each side—and in that it is designed so that the horizontal tractive forces are directly conveyed between the said spindles and the central base plate only via the direct connection facilities. In the more preferable embodiment aforementioned and according to the invention, the coupling device comprises two direct connection stay rods, to the central base plate, of the spindles of two opposing lateral wheels, the length of each stay rod being designed to allow the spindles to extend at least to their operation position, on their course set by the suspension facilities, where they are the furthest away from one another.

The mobile part of the suspension facilities of each wheel is guided with regard to the chassis by the suspension facilities with a unique margin of freedom according to the pre-set course. The course of the mobile part of the suspension facilities is either straight or curved, and comprises a vertical component, thus allowing displacements in height.

Favourably and according to the invention, the articulation of the spindle comprises at least a swivel axis orthogonal to the tangent to the course of the mobile part of the suspension facilities. If the said course is vertically straight, the articulation of the spindle may be reduced at this swivel axis, to a set position with regard to the spindle (i.g. held in a spindle clevis). If the said course is tilted with regard to the vertical and/or curve, the articulation of the spindle can again be reduced at this swivel axis on the basis that this swivel axis is constrained, in one way or another, to remain orthogonal to the tangent to the course of the mobile part of the facilities in all the positions of this mobile part along its course, and that the linking means at the other end of the stay rod bear the corresponding motions of the stay rod. If the spindle is perfectly attached to the mobile part of the suspension facilities, the swivel axis will always remain orthogonal to the said tangent and can be set with regard to the spindle.

Nevertheless, it is more preferable to envisage a second possibility of relative motion between the stay rod and the spindle according to a second swivel axis parallel to the said tangent (and thus orthogonal to the first swivel axis described above). Thus, the axle having at least two opposing lateral wheels, the spindle articulation of at least one of the spindles comprises two orthogonal swivel axes, of which one being a swivel axis orthogonal to the tangent to the course of the mobile part of the suspension facilities. More preferably, the two spindle articulations (the two spindles of the two opposing wheels) are similar. In particular, favourably and according to the invention, they both comprise two orthogonal swivel axes.

The two swivel axes can be either disjoint or secant. Favourably and according to the invention, the axle having at least two opposing lateral wheels, the spindle articulation of at least one of the spindles is a central point connection that can be made, for example, of a knuckle or a gimbal joint.

Alternatively, favourably and according to the invention, the axle having at least two opposing lateral wheels, the spindle articulation comprises a swivel axis fitted with a radial play capable of allowing the relative motions according to a pre-set amplitude perpendicular to this swivel axis. Favourably and according to the intervention, this swivel axis is orthogonal to the tangent to the course of the mobile part of the suspension facilities. In particular, it is at least roughly horizontal. For example, this swivel axis is assembled in a clevis with an interposed resilient cylinder, notably of a silent block type.

In addition, favourably and according to the invention, the second end of at least one of the stay rods is linked to the central base plate and/or to another opposing stay rod by an articulation, known as central base plate articulation, comprising at least one horizontal swivel axis. More preferably, in the case of an axle with independent, opposing lateral wheels, favourably and according to the invention, each central base plate articulation comprises two orthogonal swivel axes, notably an orthogonal swivel axis horizontal to the stay rod, and an orthogonal swivel axis vertical to the stay rod. The vertical swivel axis allows, notably, the angle between the stay rods to be adjusted when the suspension facilities are in motion. These two axes can be disjoint or, on the contrary, secant and thus form a central point connection that can consist of a knuckle or a gimbal joint.

In an economic alternative, the central base plate articulation of at least one of the stay rods comprises a swivel axis—notably vertical—fitted with a radial play capable of allowing the relative motions according to a pre-set amplitude perpendicular to this swivel axis. In addition, favourably and according to the invention, the second end of at least one of the stay rods is solidly attached to the central base plate, that being imbedded in the central base plate. Thus, one of the stay rods is articulated to the central base plate, and the other stay rod is attached to the central base plate. In this alternative, the central base plate can be articulated at the lower end of the retention support. The central base plate articulation of the stay rod could be merged with the articulation of the retention support to the central base plate, or, on the contrary, disjoint from this articulation of the retention support.

On the contrary, in another alternative, the two stay rods can both be articulated to the central base plate. The central base plate articulation of the two stay rods could be merged into a single articulation or, on the contrary, disjoint. In this alternative, favourably and according to the invention, the central base plate is solidly attached to the lower end of the retention support.

Thus, favourably and according to the invention, the central base plate is solidly attached to one (and only one) of the stay rods, or to the retention support.

In addition, the axle being non-directional with opposing lateral wheels and the suspension facilities being of a type that allows for a directional swivelling the wheels, that being a swivelling of the wheels corresponding to a change in the vehicle's direction, the coupling device according to the invention is favourably characterised in that each spindle is linked to the corresponding stay rod via a connecting lock rod extending between a fixed point on the stay rod and an articulation on the spindle, other than the articulation of the stay rod's spindle. Consequently, the coupling device also serves to lock up the wheels of the non-directional axle, having noted that the horizontal motions of the stay rods with regard to the chassis are generally minimal.

The invention extends to a towing vehicle comprising a chassis and at least a drive axle with at least one drive wheel coupled to the transmission facility of a driving motion, and suspended to the chassis by suspension facilities via a spindle supported by a mobile part of the suspension facilities, characterised in that it comprises at least one coupling device according to the invention. The axle may have only one wheel, the vehicle being, for example, a bicycle or a motorcycle. More preferably, the axle comprises at least two opposing lateral wheels each supported by a spindle. The axle is preferably of a broken type supporting at least two independent opposing wheels.

Favourably and according to the invention, the said axle is a rear axle, the coupling device being fitted to the rear of the vehicle acting as a towing device. The axle is driving, each wheel being coupled to a driving motor of the vehicle, which is self-propelled. More preferably, the axle is non-directional.

In addition, favourably and according to the invention, the suspension facilities of each wheel comprise a linear shock absorber comprising a solidly fixed immovable casing with regard to the chassis, and a mobile shank with possible translation motion according to a displacement axis, whose end supports the spindle, the spindle being solidly attached to the end of the mobile shank and supported with regard to the chassis solely via this mobile shank. Favourably and according to the invention, the displacement axis of the suspension facilities is tilted, at least laterally, with regard to the vertical, more preferably towards the inside of the vehicle, that being towards its longitudinal centre line. The displacement axis can also be tilted longitudinally. The displacement axis is, nevertheless, more preferably vertical than horizontal, that being tilted no more than 45 degrees with regard to the vertical.

Favourably and according to the invention, the vehicle belongs to the regulatory category of heavy tricycles or quadricycles or to light tricycles or quadricycles. Favourably and according to the invention, it is a light-duty truck for carrying materials and/or people, for example, a light-duty truck with an overhung driving cabin and a rear platform.

The invention also relates to a coupling device and a vehicle characterised in conjunction with all or part of the characteristics mentioned above and below.

Other characteristics, purposes and advantages of the invention appear upon reading the following description which refers to the attached diagrams illustrating non-exhaustive examples of applications of the invention, and in which

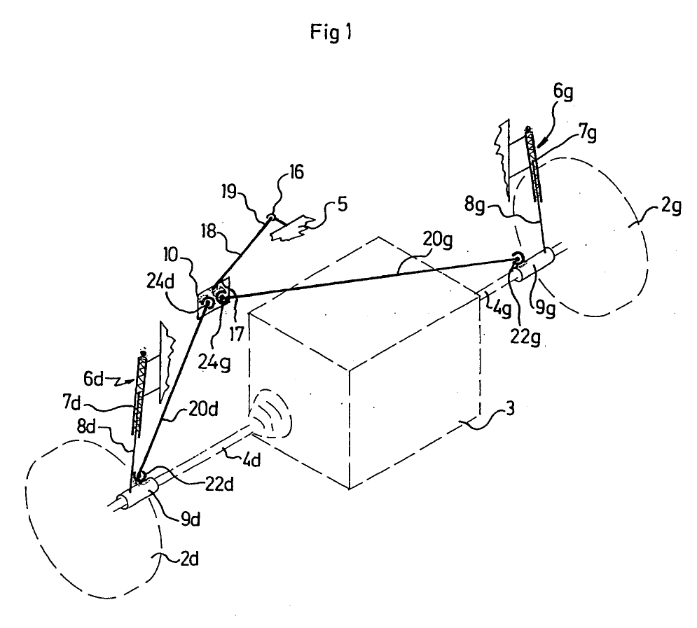

FIG. 1 is a top view diagram illustrating the kinematics of a first alternative of a coupling device according to the invention,

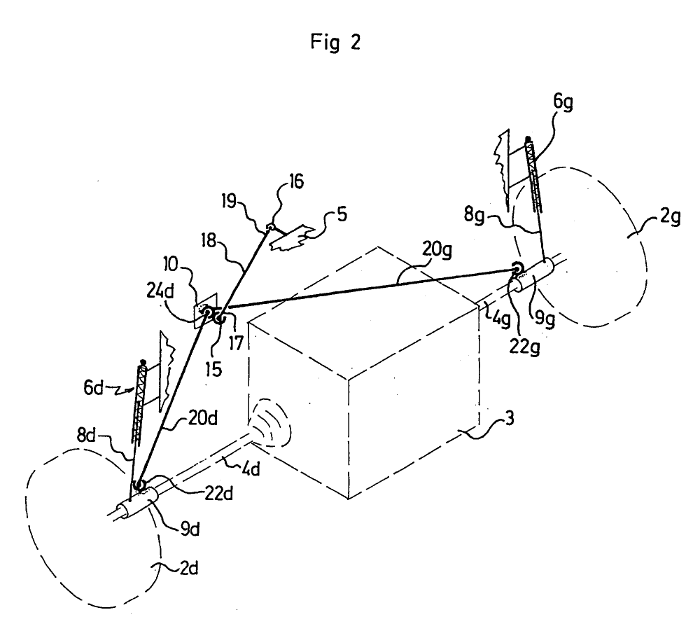

FIG. 2 is a perspective diagram illustrating the kinematics of a second alternative of a coupling device according to the invention,

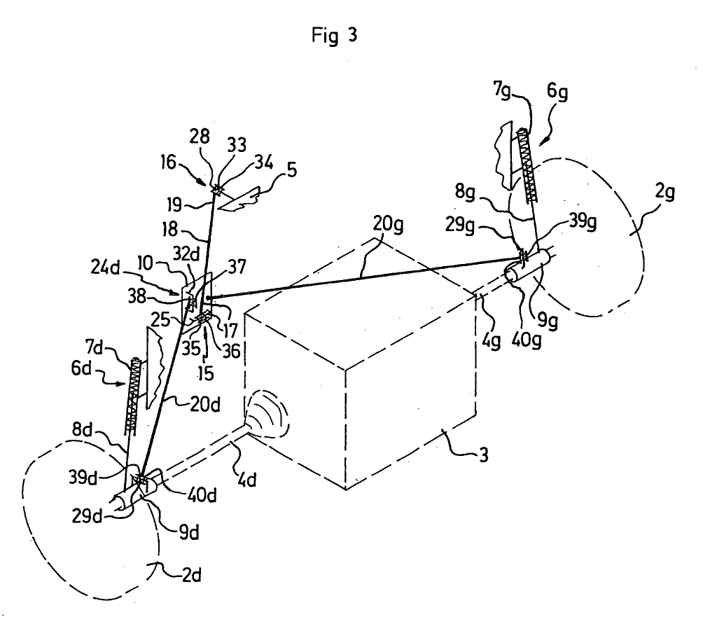

FIG. 3 is a perspective diagram illustrating the kinematics of a third alternative of a coupling device according to the invention,

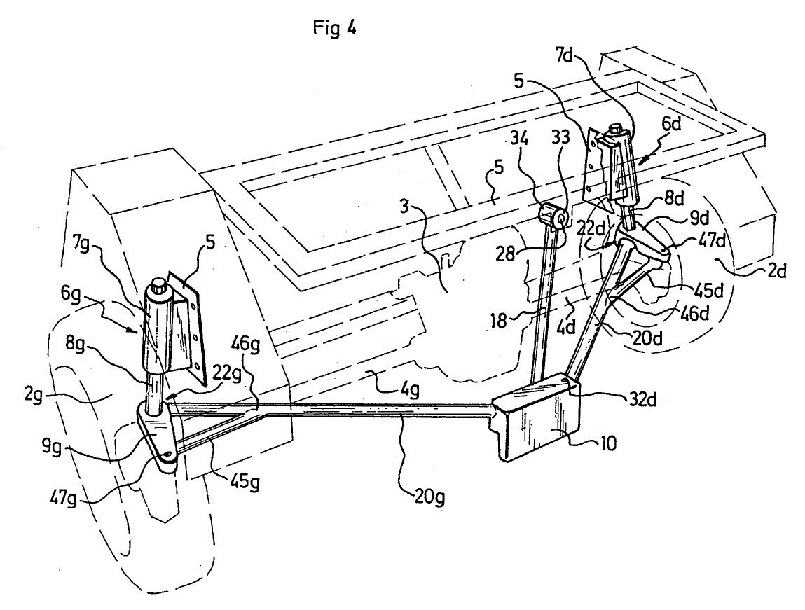

FIG. 4 is a schematic perspective view illustrating an embodiment of the third alternative of the coupling device according to the invention,

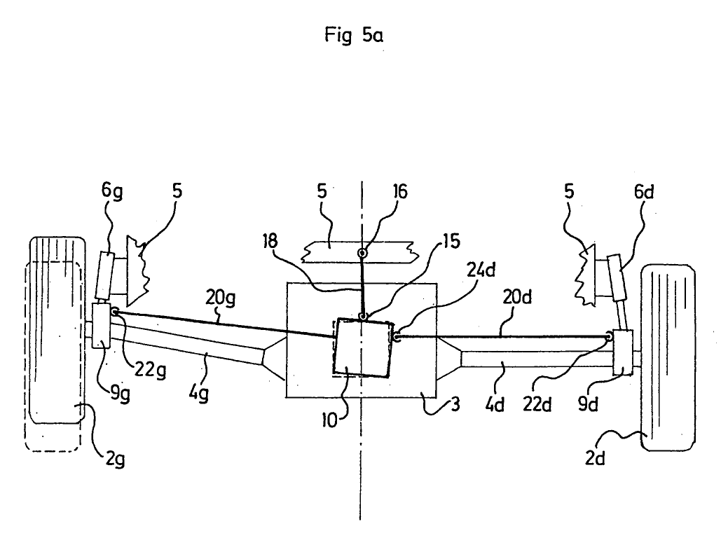

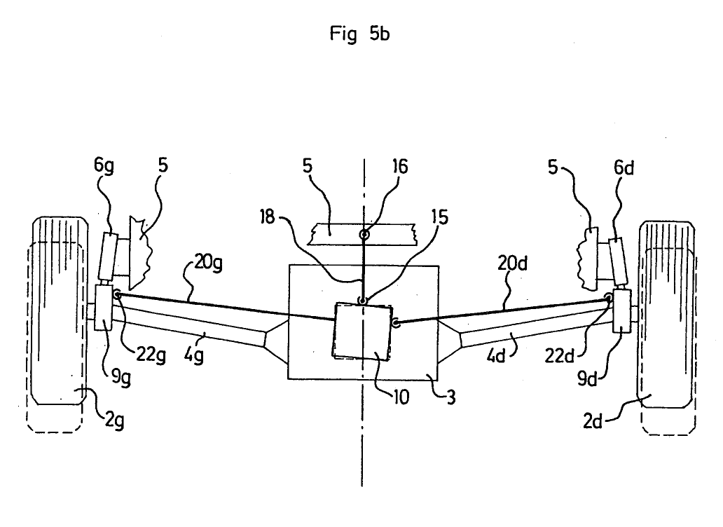

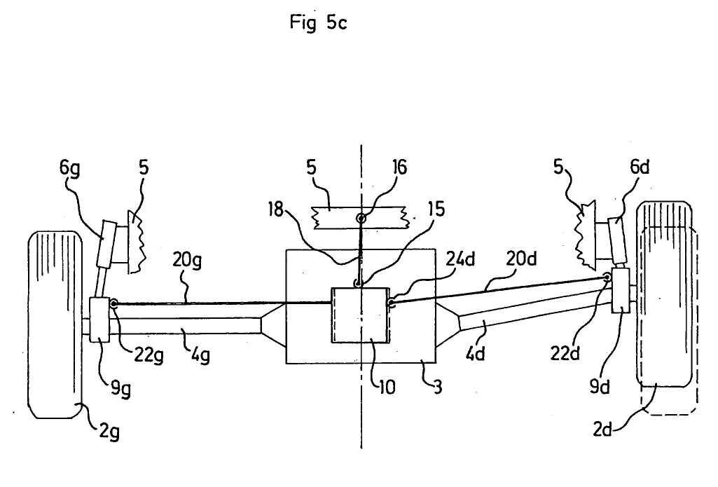

FIGS. 5a, 5b, 5c are schematic rear views illustrating the motions of a coupling device according to the invention,

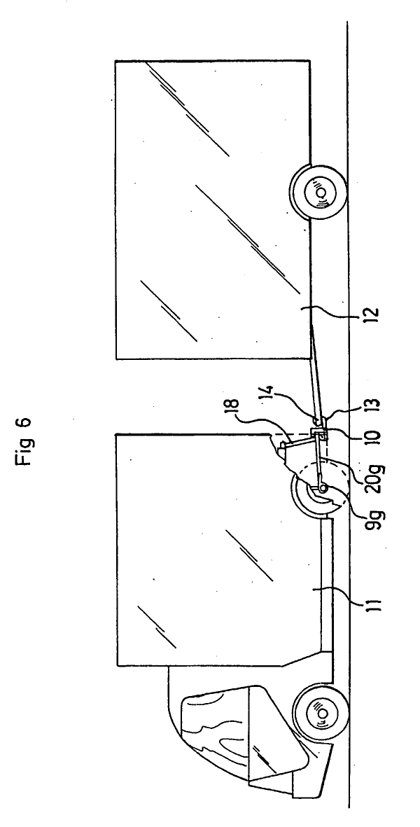

FIG. 6 is a schematic profile view illustrating a motorised vehicle according to the invention to which is coupled a trailer,

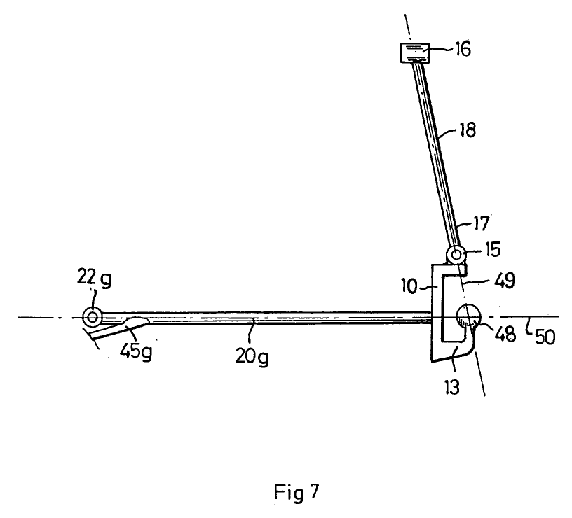

FIG. 7 is a schematic profile view illustrating the kinematics of a fourth alternative to the invention.

In the examples given in the figures, the coupling device is linked to a broken type driving rear axle 1 of a vehicle comprising two independent, opposing lateral wheels, that being one left driven wheel 2g and one right driven wheel 2d, rotation driven by the engine device 3 via the two independent drive shafts 4g respectively 4d.

Throughout the following, the value g represents an element on the left side of the vehicle (in respects to its forward motion) and value d represents a similar element on the right side of the vehicle.

Each of the wheels 2g, 2d is suspended from the chassis 5 of the vehicle via an independent suspension 6g, 6d (which is specific to the wheel) comprising a casing 7g, 7d solidly attached and immovable with regard to the chassis 5, for example via bolting, and a mobile part 8g, 8d that is in the examples, a mobile shank 8g, 8d in translation with regard to the casing 7g, 7d. The mobile part 8g, 8d of the suspensions 6g, 6d is guided by the casing 7g, 7d and is linked to the casing 7g, 7d via a resilient element such as a compression spring and/or a volume of compressed air and hydraulic shock absorbing facilities, for example, a volume of oil. Each wheel 2g, 2d is suspended to the suspension 6g, 6d via a part 9g, 9d, known as spindle, supported by the mobile part 8g, 8d, notably, solidly attached to the lower end of the mobile shank 8g, 8d of the suspension 6g, 6d. This spindle 9g, 9d bears a wheel hub 2g, 2d and guides the latter in its rotation. The wheel hub goes through the axis of the spindle 9g, 9d to be coupled to the corresponding drive shaft 4g, 4d via a homokinetic joint (gimbal joint).

The coupling device according to the invention comprises a coupling central base plate 10 capable of being fitted with coupling facilities 13, 14 of another vehicle (trailer) for towing purposes, and to convey the tractive forces of the towing vehicle 11 according to the invention to the trailer vehicle 12 (FIG. 6).

The central base plate 10 is generally situated, in normal position, at least roughly centred according to the longitudinal median direction of the vehicle 11. This base plate 10 can be fitted with, for example, a pintle hook 13 with a hitch ball 48 being equipped with a concave empty spherical brake hose coupler 14 attached to the trailer vehicle 12. The pintle hook 13 can be a distinct and removable part of the central base plate 10 or, on the contrary, be formed of a single part, constituting the central base plate 10 and the pintle hook 13.

According to an alternative of FIG. 1, the central base plate 10 is solidly attached to the lower end 17 of a rigid retention beam 18, whose upper end 19 is articulated by an articulation, known as upper articulation 16, to a fixed point on the chassis 5. The central base plate 10 is suspended from the chassis 5 by a retention beam 18 which allows multidirectional pendulum motion inhibiting all downward displacements of the central base plate 10 from its normal position which is the lowest position. The retention beam 18 extends downwards from the upper articulation 16 towards the central base plate 10, and can be vertical or, on the contrary, tilted with regard to the vertical as in the given examples.

In addition, two stay rods 20g, 20d in the form of rigid beams, link each of the spindles 9g, 9d to the central base plate 10. The stay rods 20g, 20d are linked to each of the spindles 9g, 9d and to the central base plate 10, so that they form direct connection facilities between the spindles 9g, 9d and the central base plate 10 designed so that the horizontal longitudinal tractive forces are conveyed directly between the central base plate 10 and each of the spindles 9g, 9d, and only via these stay rods 20g, 20d. In other words, the entire coupling device according to the invention—in particular the retention beam 18 and its lower 15 and upper 16 articulations, as well as the two stay rods 20g, 20d, and the manner in which they are linked to the spindles 9g, 9d, and to the central base plate 10—is designed so that the horizontal longitudinal tractive forces are conveyed directly from the spindles 9g, 9d, via the stay rods 20g, 20d, to the central base plate 10, without going through the retention beam 18 nor the chassis 5.

In a coupling device according to the invention, the central base plate 10 is solidly attached to one of the two stay rods 20g, 20d or to the retention beam 18, so as to at least roughly maintain a constant height and the same orientation in comparison with the vertical, that meaning without being able to tilt around a horizontal axis.

Thus, the vertical forces subjected to the central base plate 10 and the coupling facilities 13, 14 are passed on to the chassis 5 via the retention beam 18. In this way, with a coupling device according to the invention, the chassis 5 is not subjected to the horizontal tractive forces and the non-suspended weight of the vehicle is not increased when a trailer 12 is attached.

The rigid retention beam 18 directly conveys to the chassis 5 the vertical downward or upward component of the forces, known as tractive forces, subjected to the central base plate 10. Thus, in the case of a trailer 12 with a single axle, the coupling device maintains the angle of this trailer 12.

In the case of a trailer with several axles and an articulated draw barn around a horizontal transversal axis, the retention beam 18 could, in a non-represented alternative, be removed, the trailer itself determining the height of the central base plate 10, the vertical component of the tractive forces conveyed to the chassis 5 of the towing vehicle being nil or negligible. According to this alternative, to nevertheless avoid the dropping through of the central base plate 10 to the ground when there is no trailer attached, a cable or coupling facility is therefore envisaged, or the coupling device is removable from the towing vehicle (the stay rods 20g, 20d being removable from the spindles 9g, 9d).

According to another non-represented alternative, the height of the central base plate 10 can be determined by one or several wheels linked to a coupling device, for example to the central base plate 10 and/or the stay rods 20g, 20d to drive on level ground.

The inventor based his work on the fact that, in a drive axle, the tractive forces originating on the interference between the ground and each of the driven wheels 2g, 2d driven by the engine 3, are conveyed to the spindles 9g, 9d supporting the wheels 2g, 2d, and can therefore be taken directly from the spindles 9g, 9d to be conveyed to the trailer vehicle 12 via the coupling facilities 13, 14 without going through the chassis 5 of the towing vehicle 11.

In addition, as this will be explained later, the inventor determined that despite the presence of the suspensions 6g, 6d so that the wheels 2g, 2d are in constant motion in comparison to the chassis 5, it is possible and favourable to directly link the spindles 9g, 9d to a central base plate 10 which is at least roughly held to a pre-set height, and notably to a set height with regard to the chassis 5 thanks to the retention beam 18 (the pendulum motions authorised by the retention beam 18, of low amplitude, being comparable to the horizontal translations).

The stay rods 20g, 20d are comprised of sized-up rigid metal beams to convey the horizontal tractive forces between the central base plate 10 and each of the spindles 9g, 9d. Each stay rod 20g, 20d is articulated at its end before 21g, 21d to the corresponding spindle 9g, 9d via an articulation, known as spindle articulation 22g, 22d. In addition, each stay rod 20g, 20d has a rear end 23g, 23d which is linked to the central base plate 10. According to the alternative represented in FIG. 1, the central base plate 10 is solidly attached to the lower end of the retention beam 18, and the two rear ends 23g, 23d are articulated by separate articulations 24g, 24d on the central base plate 10.

According to the implementation alternatives of FIGS. 3 to 7, the rear end 23g of the left stay rod 20g is solidly attached to the central base plate 10, for example via welding, whereas the rear end 23d of the right stay rod is articulated to the central base plate 10 by a central base plate articulation 24d. Indeed, this single articulation is in practice sufficient to ensure the relative motion of the two stay rods 20g, 20d one in respects to the other imposed by the motion of the spindles 9g, 9d during the motion of the mobile parts 8g, 8d with regard to their suspensions 6g, 6d. The central base plate 10 is therefore articulated by an articulation, known as lower articulation 15, to the lower end 17 of the retention beam 18. The central base plate (10) being solidly fixed to one of the stay rods (and solely to one of the two stay rods) is held up with regard to the chassis and at least roughly maintains its orientation in respects to the vehicle, so that the vertical tractive forces are applied to the chassis 5 by the retention beam 18. Nevertheless, the central base plate 10 is subject to some swivel and/or horizontal translation motion with regard to the chassis 5. However, these motions are in fact of very low amplitude, the base plate 10 being also held in position at a pre-set height thanks to the retention beam 18 to which it is suspended. This retention beam 18 as well as the lower 15 and upper 16 articulations are thus designed to allow certain rotation or translation motions of the central base plate 10 in comparison to the chassis 5, as and when there is motion of one and/or the other of the spindles 9g, 9d, excluding downward displacement from the normal position. The motions of each spindle 9g, 9d are determined by the kinematics of the suspensions 6g, 6d which impose a pre-set trajectory, with a unique degree of freedom, to the mobile part 8g, 8d and to the spindle 9g, 9d. This mobile part 8g, 8d as well as the spindle 9g, 9d can therefore move according to a trajectory which is rectilinear in the given examples, but which could be curvilinear, and which comprises mainly a vertical component allowing motions in height so as to absorb the unevenness of the ground. Generally speaking, this trajectory is not purely vertical and more or less laterally tilted to the inside (that being towards the longitudinal median vertical plane of the vehicle) so as to provide the greatest anti-roll stability to the vehicle. The trajectory could also be longitudinally tilted compared to the vertical, towards the front for the rear wheels and towards the back for the front wheels so as to optimise the pitching behaviour of the vehicle. All the same, the trajectory of the spindles 9g, 9d is imposed by the suspensions 6g, 6d and defined with regard to the desired characteristics and performance of the vehicle.

The coupling device according to the invention must therefore adjust to this trajectory to allow the tractive forces to be conveyed in all relative positions of the wheels 2g, 2d. This is simply achieved by an appropriate choice of the articulation(s) of the retention beam 18, of the articulations of the spindle 22g, 22d and of the central base plate articulations 24g, 24d of the stay rods 20g, 20d, as well as the choice of an adequate length for the stay rods 20g, 20d. In particular, the length of the stay rods 20g, 20d must be sufficient to link the two spindles 9g, 9d to the central base plate 10 in the position where the spindles 9g, 9d are as far as possible from each other, generally corresponding to the maximum extension of the suspensions 6g, 6d.

In the second implementation alternative of the coupling device according to the invention represented in FIG. 2, the upper 15 and lower 16 articulations of the retention beam 18 are knuckles, that being central point connections. They can be replaced by gimbal joints or non-secant orthogonal swivel double axis articulations, that being a horizontal transversal swivel axis and a horizontal longitudinal swivel axis. In this way, the retention beam 18, can have a pendulum motion compared to the chassis 5 and the base plate 10 can swivel in all way and directions compared to the lower end 17 of the retention beam 18. Consequently, the central base plate 10 can move forwards or backwards or from left to right at least roughly horizontal or along any horizontal direction compared to the chassis 5 whilst roughly remaining at the same height (the pendulum motions could be compared to translation motions in the plane given their low amplitude) so as to follow the motions of spindles 9g, 9d compared to the chassis 5 during the course of the suspension 6g, 6d. The base plate 10, remaining at least roughly at the same height, could also be swivelled around a horizontal transversal swivel axis when the spindles 9g, 9d rise or drop and around a horizontal longitudinal swivel axis if necessary.

Likewise, in the implementation alternatives represented in FIGS. 1 and 2, the articulations of the spindles 22g, 22d are knuckles, that being central point connections. In a non-represented alternative these spindle articulations 22g, 22d could be in the form of a grimal joint, or an articulation made of two non-secant orthogonal swivel axes, that being a swivel axis orthogonal to the tangent to the trajectory of the mobile part 8g, 8d of the suspension facilities, that being orthogonal to the direction of the mobile shank 8g, 8d in the given examples, as well as a swivel axis parallel to the tangent to the trajectory of the mobile part 8g, 8d of the suspensions 6g, 6d, that being orthogonal to the previous one. Likewise, the central base plate articulations 24g, 24d are knuckles, that being central point connections. In a non-represented alternative, these central base plate articulations could each be in the form of a grimal joint or an articulation made of two non-secant orthogonal swivel axes, that being a horizontal pendulum swivel axis perpendicular to the general direction of the stay rod 20g, 20d, and a vertical swivel axis which is therefore orthogonal to the previous one.

Thanks to these different articulations comprising each one at least two orthogonal swivel axes or a central point, all the motions in the area of the stay rods 20g, 20d one with regard to the other and compared to the central base plate 10 are authorised, as the central base plate 10 can remain at least roughly in the central position compared to the chassis 5 of the vehicle. The horizontal longitudinal and/or transversal tractive force applied to the base plate 10 is not passed on to the chassis 5, notably, given that the retention beam 18 is articulated to the chassis 5 by the upper articulation 16 which, notably, incorporates a horizontal transversal swivel axis. All the horizontal tractive forces are therefore conveyed to the two stay rods 20g, 20d and then to the spindles 9g, 9d which then convey them on to the wheels 2g, 2d, irrespective of the position of the spindles 9g, 9d and of the mobile part 8g, 8d of the suspensions 6g, 6d on their trajectory.

It is to be noted however, that during towing, the angle between the two stay rods 20g, 20d tends to diminish due to the effect of the main horizontal longitudinal component of the tractive forces. This diminishing of the angle is inhibited by the kinematics of the suspensions 6g, 6d which define the clearance between the two wheels 2g, 2d, as well as by the friction between the two wheels 2g, 2d and the ground. Thus, if the two suspensions 6g, 6d could be subjected to a certain part of the transversal component of the horizontal tractive forces corresponding to the diminishing of the angle between the two stay rods 20g, 20d and or to the lateral dynamic imbalances during haulage, this part is in practice negligible, considering the sizing-up of the suspensions 6g, 6d which must be sufficient to support the weight of the towing vehicle 11.

The FIGS. 1 and 2 are only theoretical kinematic diagrams and all appropriate implementation forms can be adopted to create the different swivel axes and articulations, for example, with the help of clevises, bolts, bearings . . .

According to the alternatives of FIGS. 1 and 2, the articulations are all formed of central point connections. Such central point connections can be made in any known form (knuckle with relative sliding motion, knuckle formed by bearings, gimbal type joint devices, for example comprising a central spider and two orthogonal clevises . . . ).

According to the third implementation alternative represented in FIGS. 3 and 4, the upper articulation 16 is formed of a horizontal longitudinal swivel axis 28 attached to the chassis 5 fitted with a radial play via a resilient cylinder 33 (silent block) in an empty cylindrical support 34 attached to the retention beam 18. The lower articulation 15 is formed of a horizontal transversal swivel axis 25 attached to the central base plate 10 and fitted with a radial play via a resilient cylinder 35 (silent block) in an empty cylindrical support 36 attached to the retention beam 18. The articulation 24d of the central base plate of the right side stay rod 20d, is formed of a vertical swivel axis 32d attached to the central base plate 10 and fitted with a radial play via a resilient cylinder 37 (silent block) in an empty cylindrical support 38 attached to the stay rod 20d. The two spindle articulations 22g, 22d are both formed of a swivel axis 29g, 29d attached to the spindle 9g, 9d (thanks to a clevis of the spindle 9g, 9d), and orthogonal to the course direction of the mobile part 8g, 8d of the suspensions 6g, 6d , this swivel axis 29g, 29d being fitted with a radial play via a resilient cylinder 39g, 39d (silent block) in an empty cylindrical support 40g, 40d attached to the stay rod 20g, 20d. These assemblies with swivel axes fitted with a radial play via resilient cylinders allow the different relative motions of rotation and/or translation of the stay rods 20g, 20d one in respects to the other, with regard to the central base plate 10 and in comparison to the chassis 5.

In addition, it can be envisaged that the articulations of the spindle 22g, 22d and/or of the central base plate 24g, 24d and/or the upper articulation 16 and/or the lower articulation 15 of the retention beam 18 can be removable—notably quickly removable (fixed via pins or bolts . . . )—so as to allow the disassembling of part or of the entire coupling device of the vehicle, and its assembly to the vehicle as and when needed. Nothing prevents, in certain applications, planning that these articulations are irremovable or difficult to remove (only with a special tool), so that the coupling device remains linked to the vehicle without the possibility of removing it.

As can be seen in FIGS. 1 and 7, favourably and according to the invention, the central base plate 10 is linked via its upper part to the lower end 17 of the retention beam, so that the hitch ball 48 at least roughly fits through the axis 49 of the retention beam 18. We thus avoid the creation of interfering torque, the forces applied to the retention beam 18 by the hitch ball 48 and the base plate 10 being orientated according to the axis 49 of this retention beam 18. Likewise, the hitch ball 48 is fixed to the central base plate 10 in such a way that it at least roughly lies in the plane 50 of the stay rods 20g, 20d, so that the horizontal forces applied to the stay rods 20g, 20d are in the axis of the stay rods 20g, 20d.

The FIGS. 5a, 5b, 5c represent three examples of motion according to three different positions of the wheels 2g, 2d one in respects to the other.

The kinematics of the coupling device represented in FIGS. 5a, 5b, 5c is similar to that of FIGS. 3 and 4, with the exception that the articulations are represented in the form of knuckles and that the lower articulation 15 of the retention beam 18 is in the upper part of the base plate 10, as in the alternatives of FIGS. 1 to 7.

In FIG. 5a, the left side wheel 2g has risen, whereas, the right side wheel 2d has not risen with regard to the chassis 5. The retention beam 18 has swivelled slightly to the right and the central base plate 19 has slightly moved to the right by swivelling with the left stay rod 20g (its normal position being represented by the dotted line). Depending on the angle of the suspension 6g, the central base plate 10 may or may not be moved longitudinally.

If, from this position, the right side wheel 2d has risen, the angle of the central base plate 10 does not change but it moves to the left in the central position on the longitudinal median direction, the retention beam 18 returning to a longitudinal median plane. Simultaneously, the angle between the two stay rods 20g, 20d being modified, a horizontal longitudinal displacement (toward either the front or the back) may occur, depending on the longitudinal angle of the suspensions 6g, 6d.

In FIG. 5c, the right side wheel 2d has risen, whereas, the left side wheel 2g has not risen with regard to the chassis 5. The retention beam 18 has swivelled slightly to the left and the central base plate 10 has moved slightly to the left in translation without swivelling.

In addition, when the suspensions 6g, 6d consist of simple linear shock absorbers, as in the given examples, allowing a directional swivelling of the wheels 2g, 2d, and when the corresponding axle is non-directional, the coupling device according to the invention can be used to lock the said wheels 2g, 2d by inhibiting directional swivelling as represented in FIG. 4. To do this, each spindle 9g, 9d is linked to the corresponding stay rod 20g, 20d via a lock rod 45g, 45d extending between a fixation point 46g, 46d on the stay rod 20g, 20d and an articulation 47g, 47d of this lock rod 45g, 45d on the spindle 9g, 9d, this articulation 47g, 47d being separate and far from the spindle articulation 22g, 22d of the stay rod 20g, 20d on the spindle 9g, 9d. The triangle formed by the spindle 9g, 9d between the two articulations 22g, 22d and 47g, 47d, the lock rod 45g, 45d, and the section of stay rod 20g, 20d extending between the fixation point 46g, 46d and the spindle articulation 22g, 22d, prohibits the swivelling of the wheel 2g, 2d around the axis of the suspension 6g, 6d. The lock rod 45g, 45d is solidly attached to the fixation point 46g, 46d of the stay rod 20g, 20d, for example, via welding. The articulation 47g, 47d is more preferably a knuckle but could also consist of a swivel axis fitted in the silent block with a radial play or of two disjoint orthogonal swivel axes.

This form of implementation of the locking of wheels 2g, 2d via a coupling device according to the invention is particularly advantageous when the suspensions 6g, 6d, consist of simple linear shock absorbers, each spindle 9g, 9d being solidly fixed to the end of the mobile shank 8g, 8d and solely supported with regard to the chassis 5 by this mobile shank 8g, 8d. We thereby implement the suspensions 6g, 6d as well as the locking of the wheels 2g, 2d of the non-directional axle in a very simple, economic and light manner. Nevertheless, it is clear that any other form of implementation can be envisaged. Thus, it is also possible to lock the wheels 2g, 2d by any traditional triangulation system.

The FIG. 6 represents a towing vehicle 11 according to the invention consisting of a light-duty truck with an overhung driving cabin belonging to the regulatory category of heavy self-propelled quadricycles, and fitted with a rear coupling device according to the invention. Thanks, notably to the invention, the chassis 5 of the towing vehicle 11 does not need to be reinforced in order to attach the coupling device, and hence the vehicle has a curb weight that corresponds to the regulatory category of heavy self-propelled quadricycles.

Moreover, the horizontal tractive forces applied to the spindles 9g, 9d, at a low point compared to the ground can only induce a limited rolling effect or over turning of the towing vehicle 11, for example, in a bend and on a downward slope or in reverse gear when the tractive forces are orientated towards the front of the trailer 12. The overall dynamic behaviour is greatly improved compared to previous coupling devices, and all the more so as the non-suspended weight of the axle is barely affected by the coupling device according to the invention.

The invention could accept many other implementation alternatives and applications. A coupling device according to the invention can be linked to a drive axle with a single drive wheel, for example the rear wheel of a motorcycle, or to any other category of road vehicle, for the transportation of people and/or materials and/or objects (car, truck, wagon . . . ) with the same advantages. It is also compatible with any other form of implementation of wheel suspensions and with axles comprising several juxtaposed wheels (the coupling device can be linked to the spindles of the outside or inside wheels, or both). In addition, the direct connection facilities formed by the stay rods 20g, 20d can be carried out under any other equivalent form, for example, with the use of cables and according to any other geometry or kinematics adapted to the vehicle. The length of the stay rods 20g, 20d and/or of the retention beam 18 is fixed and non-adjustable in the given examples, however, according to an alternative, it could be adjustable (e.g. as a steering rod would be, the stay rods and/or the beam consisting of two shanks screwed one to the other). The coupling device is also compatible with a directional axle, meaning that it could be linked to the spindles of the directional wheels of the vehicle.

Instead of being a broken axle with independent wheels as in the given examples, the axle fitted with the coupling device could be a rigid axle, the two spindles 9g, 9d and the two wheels being linked to a rigid transmission. The inconvenience of this alternative is nevertheless the increase in the non-suspended weight of the axle.

In addition, in theory, the rear coupling device may not be linked to the rear axle, but rather to the front axle of the towing vehicle if the latter has a drive axle.

1/- Coupling device of a towing vehicle comprising at least one towing axle with at least one drive wheel (2g, 2d) coupled to transmission facilities (4) of a motor motion, and suspended by suspension facilities (6g, 6d) to a vehicle chassis (5) via a spindle (9g, 9d) supported by a mobile part (8g, 8d) of the suspension facilities (6a, 6d), this device comprising a coupling central base plate (10) capable of being fitted with the coupling facilities (13, 14) of a trailer (12) with the purpose of towing and conveying the tractive forces, characterised in that it comprises direct connection facilities (22g, 22d, 20g, 20d, 24g, 24d) of the spindle (9g, 9d) of at least one axle wheel (2g, 2d) to the central base plate (10) designed to directly convey between the said spindle (9g, 9d) and the central base plate (10) a horizontal longitudinal component of the tractive forces by allowing vertical relative displacements of the said spindle (9g, 9d) with regard to the central base plate (10).

2/- Device according to claim 1, characterised in that it is designed so that a horizontal component of the tractive forces is directly conveyed by the said direct connection facilities (22g, 22d, 20g, 20d, 24g, 24d), and solely via these direct connection facilities independent of the chassis (5), between the said spindle (9g, 9d) and the central base plate (10), and so that a downward vertical component of the tractive forces subjected to the central base plate (10) is directly conveyed to the chassis (5) and not to the said spindle (9g, 9d).

3/- Device according to one of the claims 1 or 2, characterised in that it comprises retention facilities (15, 16, 18) linking the central base plate (10) to the chassis (5) designed so that the downward vertical component of the tractive forces subjected to the central base plate (10) is conveyed to the chassis (5).

4/- Device according to claim 3, characterised in that the retention facilities (15, 16, 18) are designed to maintain the central base plate (10) at least roughly at the pre-set height with regard to the chassis (5), and to convey to the chassis (5) the vertical component of the tractive forces subjected to the central base plate (10), and in that the direct connection facilities (22g, 22d, 20g, 20d, 24g, 24d) are designed to allow the vertical relative displacements of the said spindle (9g, 9d) with regard to the central base plate (10) and at least roughly independently of the central base plate (10) as determined by the motions of the mobile part (8g, 8d) of the suspension facilities (6g, 6d) with regard to the chassis (5).

5/- Device according to one of the claims 3 or 4, characterised in that the retention facilities (15, 16, 18) comprise a retention beam (18) articulated at one of its end (19) to a fixed point on the chassis (5) and linked by another of its ends (17) to the central base plate (10).

6/- Device according to claim 5, characterised in that the articulation (16) of the retention beam (18) to the chassis (5) comprises two orthogonal swivel axes, one being a horizontal transversal swivel axis an the other being a horizontal longitudinal swivel axis.

7/- Device according to one of the claims 5 or 6, characterised in that the articulation (16) of the retention beam (18) to the chassis (5) is a central point connection.

8/- Device according to one of the claims 5 to 7, characterised in that the articulation (16) of the retention beam (18) to the chassis (5) comprises a swivel axis (28) fitted with a radial play capable of allowing the relative motions according to a pre-set amplitude perpendicular to this swivel axis (28).

9/- Device according to one of the claims 1 to 8, characterised in that the direct connection facilities (22g, 22d, 20g, 20d, 24g, 24d) comprise at least one fixed length stay rod (20g, 20d) of which one end (21g, 21d) is articulated to the spindle (9g, 9d) via an articulation, known as spindle articulation (22g, 22d), and of which the other end (23g, 23d) is linked to the central base plate (10) and/or to the second end (23g, 23d), of another stay rod (20d, 20g) whose first end (21d, 21g) is articulated to a spindle (9d, 9g) of an opposing wheel.

10/- Device according to claim 9, characterised in that the spindle articulation (22g, 22d) comprises at least one swivel axis orthogonal to the tangent to the trajectory of the mobile part (8g, 8d) of the suspension facilities (6g, 6d).

11/- Device according to one of the claims 9 or 10, characterised in that the second end (23g, 23d) of at least one of the stay rods (20g, 20d) is linked to the central base plate (10) and/or to another opposing stay rod (20d, 20g) via an articulation, known as central base plate articulation (24g, 24d) comprising at least one horizontal swivel axis.

12/- Device according to one of the claims 5 to 8 and one of the claims 9 to 11, characterised in that the central base plate (10) is solidly foxed to one (20g) of the stay rods (20g, 20d) or to the retention beam (18).

13/- Device according to one of the claims 1 to 12, characterised in that the axle being of a broken type with at least two independent opposing lateral wheels (2g, 2d) fitted with independent suspension facilities (6g, 6d), it comprises direct connection facilities (22g, 22d, 20g, 20d, 24g, 24d) to the central base plate (10) of each spindle (9g, 9d) of at least two opposing lateral wheels (2g, 2d), and in that it is designed to allow the horizontal tractive forces to be directly conveyed between the spindles (9g, 9d) and the central base plate (10) solely via the direct connection facilities (22g, 22d, 20g, 20d, 24g, 24d).

14/- Device according to one of the claims 1 to 13, characterised in that the axle having at least two opposing lateral wheels (2g, 2d), it comprises two direct connection stay rods (20g, 20d), to the central base plate (10), of the spindles (9g, 9d) of two opposing lateral wheels (2g, 2d), the length of each stay rod (20g, 20d) being designed to allow the spindles (9g, 9d) to extend to at least their operation position, on their trajectory defined by the suspension facilities (6g, 6d), where they are the furthest away from one another.

15/- Device according to claim 9 and one of the claims 1 to 14, characterised in that the axle having at least two opposing lateral wheels (2g, 2d), the spindle articulation (22g, 22d) of at least one of the spindles (9g, 9d) comprises two orthogonal swivel axes, one of which being a swivel axis orthogonal to the tangent to the trajectory of the mobile part (8g, 8d) of the suspension facilities (6g, 6d).

16/- Device according to claim 9 and one of the claims 1 to 15, characterised in that the axle having at least two opposing lateral wheels (2g, 2d), the spindle articulation (22g, 22d) of at least one of the spindles (9g, 9d) is a central point connection.

17/- Device according to claim 9 and one of the claims 1 to 16, characterised in that the axle having at least two opposing lateral wheels (2g, 2d), the spindle articulation (22g, 22d) comprises a swivel axis fitted with a radial play capable of allowing the relative motions according to a pre-set amplitude perpendicular to this swivel axis.

18/- Device according to claim 7 and one of the claims 1 to 17, characterised in that the axle being non-directional with opposing lateral wheels (2g, 2d) and the suspension facilities (6g, 6d) being such as to allow a directional swivelling of the wheels (2g, 2d), each spindle (9g, 9d) is linked to the corresponding stay rod (20g, 20d) via a lock rod (45g, 45d) extending between a fixed point (46g, 46d) of the stay rod (20g, 20d) and an articulation (47g, 47d) of the spindle (9g, 9d) different from the spindle articulation (22g, 22d) of the stay rod (20g, 20d).

19/- Towing vehicle comprising a chassis (5) and at least one drive axle with at least one drive wheel (2g, 2d) coupled with transmission facilities of the driving motion, and suspended to the chassis (5) by the suspension facilities (6g, 6d) via a spindle (9g, 9d) supported by a mobile part (8g, 8d) of the suspension facilities (6g, 6d), characterised in that it comprises at least one coupling device according to one of the claims 1 to 18.

20/- Vehicle according to claim 19, characterised in that the axle comprises at least two opposing lateral wheels (2g, 2d) each supported by a spindle (9g, 9d).

21/- Vehicle according to claim 20, characterised in that the axle is of broken type, supporting at least two independent opposing wheels (2g, 2d).

22/- Vehicle according to one of the claims 19 to 21, characterised in that the said axle is a rear axle, the coupling device being situated at the rear of the vehicle acting as a towing vehicle.

23/- Vehicle according to one of the claims 19 to 22, characterised in that the axle is non-directional.

24/- Vehicle according to one of the claims 19 to 23, characterised in that the suspension facilities (6g, 6d) of each wheel (2g, 2d) comprise a linear shock absorber including a casing (7g, 7d) solidly fixed and immovable with regard to the chassis (5), and a mobile shank (8g, 8d) in translation along a displacement axis, whose end supports the spindle (9g, 9d), the spindle (9g, 9d) being solidly fixed to the end of the mobile shank (8g, 8d) and supported with regard to the chassis (5) solely via this mobile shank (8g, 8d).

25/- Vehicle according to claim 24, characterised in that the displacement axis of the suspension facilities (6g, 6d) is titled with regard to the vertical at least laterally.

26/- Vehicle according to one of the claims 19 to 25, characterised in that it belongs to the regulatory category of heavy tricycles or quadricycles, or to the category of light tricycles or quadricycles.

27/- Vehicles according to claims 19 to 26, characterised in that it is a light-duty vehicle for the transportation of materials and/or people.
